(19) United States
(12) Patent Application Publication
(10) Pub. No.: US 2011/0066797 A1
(43) Pub. Date: Mar. 17, 2011

(54) MEMORY SYSTEM

(75) Inventor: Hideki Kawazu, Yokohama (JP)

(73) Assignee: KABUSHIKI KAISHA TOSHIBA, Tokyo (JP)

(21) Appl. No.: 12/879,588

(22) Filed: Sep. 10, 2010

(30) Foreign Application Priority Data
Sep. 14, 2009 (JP) 2009-211974

(51) Int. Cl. G06F 12/10; G06F 12/00

(52) U.S. Cl. 711/105; 711/206; 711/154; 711/E12.001; 711/E12.058

(57) ABSTRACT

A memory system according to the present invention includes a bus connected to process units, a first DRAM which has a first storage area and a second storage area and which is controlled in operation by a DRAM control signal, a second DRAM which has the same bit width as that of the first DRAM, which has a third storage area having the same address space as that of the first storage area and having a capacity equal to that of the first storage area, and which is controlled in operation by the DRAM control signal, and a controller which is provided with a read command and a logical address from the process units via the bus, which controls operation of the first DRAM and the second DRAM according to the read command and the logical address, and thereby outputs data read from the first DRAM or the second DRAM to the process units via the bus.

### CROSS-REFERENCE TO RELATED APPLICATION

This application is based upon and claims the benefit of priority from the prior Japanese Patent Application No. 2009-211974, filed on Sep. 14, 2009, the entire contents of which are incorporated herein by reference.

### FIELD

The present invention relates to a memory system including two DRAMs (Dynamic Random Access Memories) which have different capacity.

### BACKGROUND

There is a conventional memory system which controls access to two DRAMs having same capacity by using one controller. However, there are no memory systems which control access to two DRAMs having different capacity by using one controller.

In conventional techniques, there is a technique in which data input/output to a plurality of SDRAMs (Synchronous Dynamic Random Access Memories) provided in parallel with a memory module is masked by using a mask signal (see, for example, JP-A 2008-293413 (KOKAI)).

However, relations between the number of controllers which generate the mask signal and capacities of the plurality of SDRAMs are not disclosed.

### BRIEF DESCRIPTION OF THE DRAWINGS

FIG. 1 is a diagram showing an example of a configuration of a memory system 100 according to a first embodiment;

FIG. 2 is a diagram showing an example of a configuration of a DRAM address space in a DRAM storage area;

FIG. 3 is a diagram showing relations between DRAM kinds and DRAM address spaces;

FIG. 4 is a diagram showing an example of a logical address in the case where the process unit accesses the first storage area in the first DRAM;

FIG. 5 is a diagram showing an example of a logical address in the case where the process unit accesses the second storage area in the first DRAM;

FIG. 6 is a diagram showing an example of a table for translating a logical address to a DRAM address;

FIG. 7 is a diagram showing another example of a logical address in the case where the process unit accesses the first storage area in the first DRAM;

FIG. 8 is a diagram showing another example of a logical address in the case where the process unit accesses the second storage area in the first DRAM;

FIG. 9 is a diagram showing another example of a table for translating a logical address to a DRAM address;

FIG. 10 is a diagram showing another example of a logical address in the case where the process unit accesses the first storage area in the first DRAM;

FIG. 11 is a diagram showing another example of a logical address in the case where the process unit accesses the second storage area in the first DRAM; and

FIG. 12 is a diagram showing another example of a table for translating a logical address to a DRAM address.

### DETAILED DESCRIPTION

A memory system according to the present embodiment includes a bus connected to process units, a first DRAM which has a first storage area and a second storage area and which is controlled in operation by a DRAM control signal, a second DRAM which has the same bit width as that of the first DRAM, which has a third storage area having the same address space as that of the first storage area and having a capacity equal to that of the first storage area, and which is controlled in operation by the DRAM control signal, and a controller which is supplied with a read command and a logical address from the process units via the bus, which controls operation of the first DRAM and the second DRAM according to the read command and the logical address, and thereby outputs data read from the first DRAM or the second DRAM to the process units via the bus.

Embodiments will now be explained with reference to the accompanying drawings.

### First Embodiment

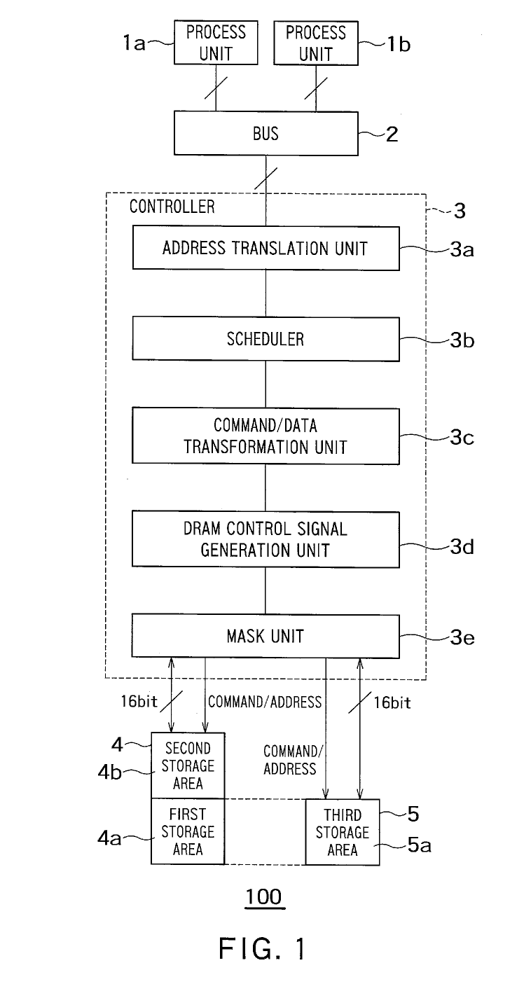

FIG. 1 is a diagram showing an example of a configuration of a memory system 100 according to a first embodiment.

As shown in FIG. 1, the memory system 100 includes process units 1a and 1b, a bus 2, a controller 3, a first DRAM 4, and a second DRAM 5.

The process units 1a and 1b are operation devices (for example, processors or bus masters) which access the DRAMs via the memory system 100.

The bus 2 is connected to the process units 1a and 1b.

The first DRAM 4 includes a first storage area 4a and a second storage area 4b. Operation of the first DRAM 4 is controlled by a DRAM control signal. The first DRAM 4 has a bit width of, for example, 16 bits. In the example shown in FIG. 1, the first storage area 4a has a capacity of 512 Mbits. However, the first storage area 4a may have a different capacity such as 1 Gbits. Incidentally, the storage area is formed of a memory cell array having memory cells arranged in a matrix form to store data.

In the example shown in FIG. 1, for example, capacity of the first storage area 4a and the second storage area 4b are equal (in this case, the total capacity of the first DRAM 4 is 1 Gbits). However, they may be different from each other.

The second DRAM 5 has the same bit width as that of the first DRAM 4. The second DRAM 5 includes a third storage area 5a having a capacity which is equal to that of the first storage area 4a in the first DRAM 4. In other words, the second DRAM 5 has a capacity which is different from that of the first DRAM 4. In addition, the third storage area 5a has the same DRAM address (physical address) space as that of the first storage area 4a. Operation of the second DRAM 5 is controlled by a DRAM control signal.

The first DRAM 4 and the second DRAM 5 are, for example, DDR2 SDRAM, or the first DRAM 4 and the second DRAM 5 are DDR3 SDRAM, or the like.

A read command (or a write command) and a logical address from the process units 1a and 1b are input to the controller 3 via the bus 2.

The controller 3 outputs data read from the first DRAM 4 and/or the second DRAM 5 to the process units 1a and 1b via the bus 2 by, for example, controlling operation of the first DRAM 4 and the second DRAM 5 with the read command and the logical address.

Furthermore, the controller 3 writes data, which is input from the process units 1a and 1b via the bus 2, into the first DRAM 4 and/or the second DRAM 5 by, for example, controlling operation of the first DRAM 4 and the second DRAM 5 according to the write command and the logical address.

In the case of access (write or read) having a wide bandwidth in the memory system 100 according to the first embodiment, for example, data of 32 bits is divided into two pieces of data each having 16 bits and the two pieces of data are written into the first storage area 4a and the third storage area 5a in parallel (or read from the first storage area 4a and the third storage area 5a in parallel).

On the other hand, in the case of access having a narrow bandwidth in the memory system 100, for example, data of 32 bits is divided into two pieces of data each having 16 bits and the two pieces of data are written into the second storage area 4b successively. As described above, the physical address space of the first DRAM 4 and the physical address space of the second DRAM 5 is different. Therefore, address translation unit 3a perform address translation with different address translation expressions in the case of access having a wide bandwidth and narrow bandwidth. As shown in FIG. 1, the controller 3 includes the address translation unit 3a, a scheduler 3b, a command/data transformation unit 3c, a DRAM control signal generation unit 3d, and a mask unit 3e.

The address translation unit 3a is adapted to perform address translation from the logical address to a DRAM address and output the resultant DRAM address. Incidentally, the DRAM address is a physical address of a memory cell in a storage area (memory cell array).

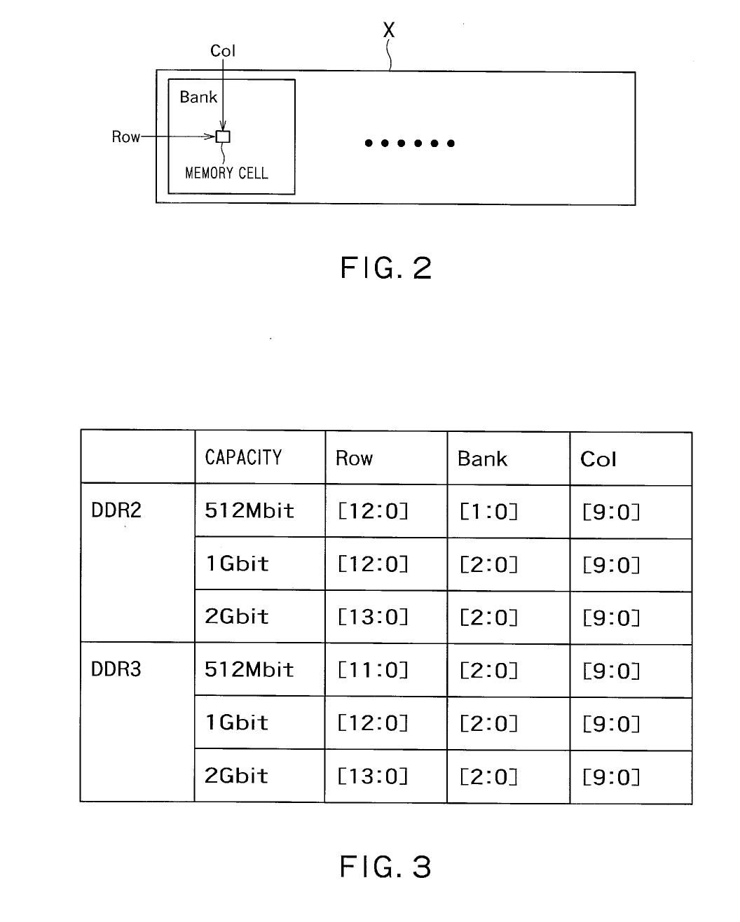

FIG. 2 is a diagram showing an example of a configuration of a DRAM address space in a DRAM storage area. As shown in FIG. 2, a DRAM storage area X is formed of a plurality of banks “Banks.” A DRAM address (physical address) of a memory cell is prescribed by a column “Col” and a row “Row” in the bank “Bank.”

FIG. 3 is a diagram showing relations between the type of DRAM and DRAM address spaces. As shown in FIG. 3, different types of DRAMs have different DRAM address spaces.

For example, comparing DDR2 1 Gbits with DDR2 512 Mbits, 2³ banks “Banks” are assigned to DDR2 1 Gbits, whereas 2² banks “Banks” are assigned to DDR2 512 Mbits.

Comparing DDR3 1 Gbits with DDR3 512 Mbits, 2¹³ rows “Rows” are assigned to DDR3 1 Gbits, whereas 2¹² rows “Rows” are assigned to DDR3 512 Mbits.

Comparing DDR2 or DDR3 2 Gbits with DDR2 or DDR3 1 Gbits, 2¹⁴ rows “Rows” are assigned to DDR2 or DDR3 2 Gbits, whereas 2¹² rows “Rows” are assigned to DDR2 or DDR3 1 Gbits.

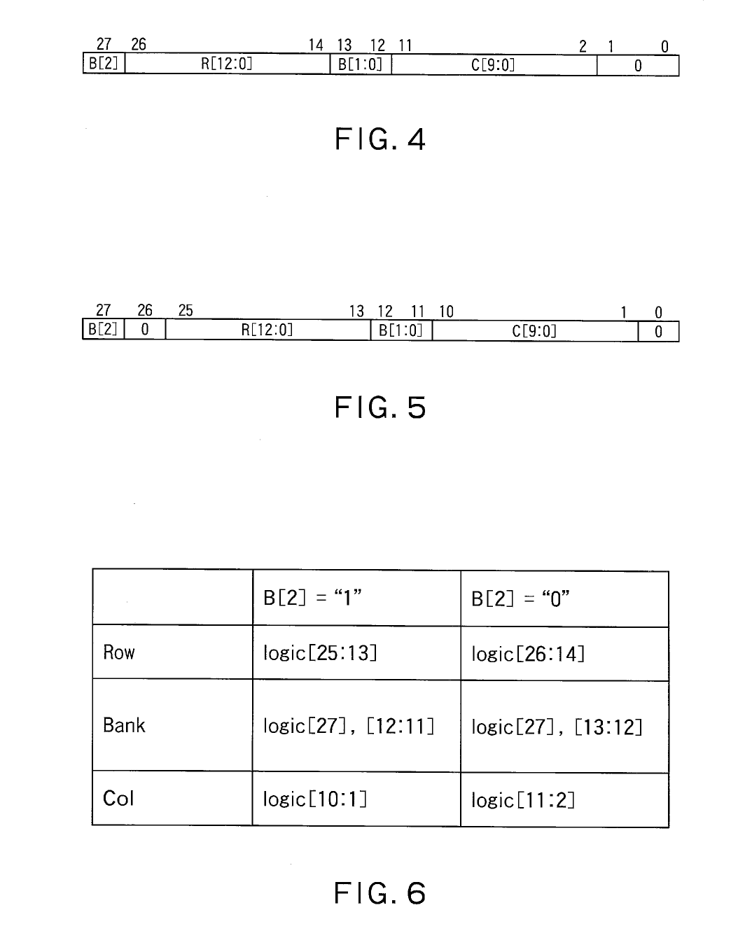

FIG. 4 is a diagram showing an example of a logical address in the case where the process unit accesses the first storage area in the first DRAM 4 and the third storage area in the second DRAM 5. FIG. 5 is a diagram showing an example of a logical address in the case where the process unit accesses the second storage area in the first DRAM 4. FIG. 6 is a diagram showing an example of a table for translating a logical address to a DRAM address.

FIGS. 4 to 6 show the case where the first DRAM and the second DRAM is an DDR2 SDRAM, the first DRAM 4 has a capacity of 1 Gbits, and the second DRAM 5 has a capacity of 512 Mbits. Among 2³ banks in the first DRAM 4, banks B0 (i.e., B[2:0]=“000”) to B3 (i.e., B[2:0]=“011”) are assigned to the first storage area 4a and banks B4 (i.e., B[2:0]=“100”) to B7 (i.e., B[2:0]=“111”) are assigned to the second storage area 4b.

In this case, it can be determined whether the access is to the first storage area 4a and the third storage area 5a or to the second storage area 4b according to whether B[2] in the 27th bit of a logical address logic [27:0] is “0” or “1” as shown in FIGS. 4 and 5.

According to the table shown in FIG. 6, therefore, the address translation unit 3a performs address translation from a logical address to a DRAM address based on the first address translation expression or the second address translation expression based on the value B[2] in the 27th bit of the logical address. Here, the first translation expression is an address translation expression having a logic [25:13] in the logic address [27:0] as a row address, having a logic [27] and a logic [12:11] as a bank address, and having a logic [10:1] as a column address. On the other hand, the second translation expression is an address translation expression having a logic [26:14] in the logic address [27:0] as a row address, having a logic [27] and a logic [13:12] as a bank address, and having a logic [11:2] as a column address. Incidentally, the first address translation expression and the second address translation expression are not limited to the above-described translation expressions.

In the present embodiment, it is classified as an access to the first storage area 4a or an access to the second storage area 4b based on the 27th bit (the highest order bit) in the logical address. Alternatively, it may be classified as an access to the first storage area 4a or an access to the second storage area 4b based on a predetermined bit in the logical address.

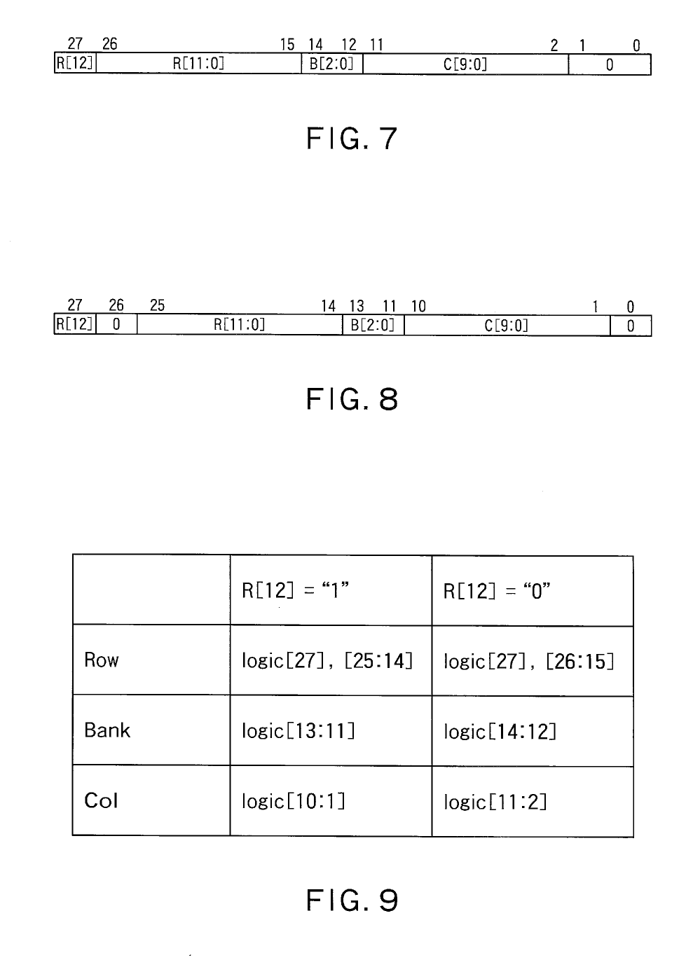

FIG. 7 is a diagram showing another example of a logical address in the case where the process unit accesses the first storage area in the first DRAM 4 and the third storage area in the second DRAM 5. FIG. 8 is a diagram showing another example of a logical address in the case where the process unit accesses the second storage area in the first DRAM 4. FIG. 9 is a diagram showing another example of a table for translating a logical address to a DRAM address.

Incidentally, FIGS. 7 to 9 show the case where the first DRAM and the second DRAM are the DDR3 SDRAM, the first DRAM 4 has a capacity of 1 Gbits, and the second DRAM 5 has a capacity of 512 Mbits. Among 2¹³ rows in the first DRAM 4, logical addresses which bring about row R[12]=“0” (i.e., R[12:0]=“000000000000” to “0111111111111”) are assigned to the first storage area 4a and logical addresses which bring about row R[12]=“1” (i.e., R[12:0]=“100000000000” to “1111111111111”) are assigned to the second storage area 4b.

In this case, it can be determined whether the access is to the first storage area 4a and the third storage area 5a or to the second storage area according to whether R[12] in the 27th bit of the logical address logic [27:0] is “0” or “1” as shown in FIGS. 7 and 8.

According to the table shown in FIG. 9, therefore, the address translation unit 3a performs address translation from a logical address to a DRAM address based on the first address translation expression or the second address translation expression based on the value R[12] in the 27th bit of the logical address. Here, the first translation expression is an address translation expression having a logic [27] and a logic [25:14] in the logical address logic [27:0] as a row address, having a logic [13:11] as a bank address, and having a logic [10:1] as a column address. On the other hand, the second translation expression is an address translation expression having a logic [27] and a logic [26:15] in the logical address logic [27:0] as a row address, having a logic [14:12] as a bank address, and having a logic [11:2] as a column address. Incidentally, the first address translation expression and the second address translation expression are not limited to the above-described translation expressions.

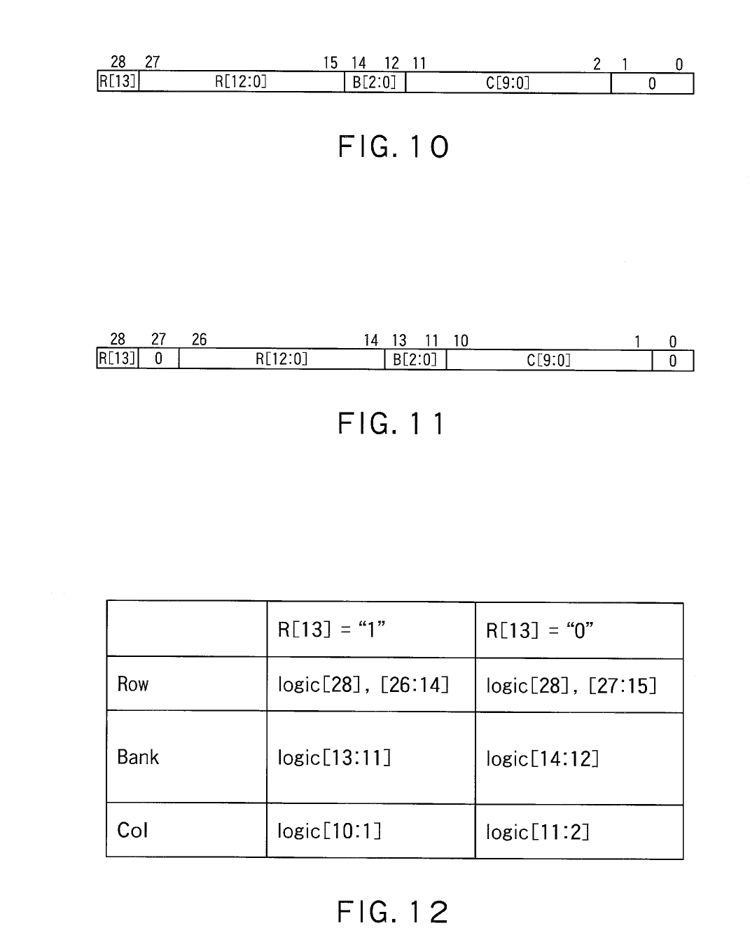

FIG. 10 is a diagram showing another example of a logical address in the case where the process unit accesses the first storage area in the first DRAM 4 and the third storage area in the second DRAM 5. FIG. 11 is a diagram showing another example of a logical address in the case where the process unit accesses the second storage area in the first DRAM 4. FIG. 12 is a diagram showing another example of a table for translating a logical address to a DRAM address.

FIGS. 10 to 12 show the case where the first DRAM 4 and the second DRAM 5 are DDR2 SDRAM or the first DRAM 4 and the second DRAM 5 are the DDR3 SDRAM, and the first DRAM 4 has a capacity of 2 Gbits, and the second DRAM 5 has a capacity of 1 Gbits. Among 2¹⁴ rows in the first DRAM 4, logical addresses which bring about R[13]=“0” (i.e., R[13:0]=“0000000000000” to “01111111111111”) are assigned to the first storage area and logical addresses which bring about R[13]=“1” (i.e., R[13:0]=“10000000000000” to “11111111111111”) are assigned to the second storage area.

In this case, it can be determined whether the access is to the first storage area or to the second storage area 46 according to whether R[13] in the 28th bit of the logical address logic [28:0] is “0” or “1” as shown in FIGS. 10 and 11.

According to the table shown in FIG. 12, therefore, the address translation unit 3a performs address translation from a logical address to a DRAM address based on the first address translation expression or the second address translation expression based on the value R[13] in the 28th bit of the logical address. Here, the first translation expression is an address translation expression having a logic [28] and a logic [26:14] in the logical address logic [28:0] as a row address, having a logic [13:11] as a bank address, and having a logic [10:1] as a column address. On the other hand, the second translation expression is an address translation expression having a logic [28] and a logic [27:15] in the logical address logic [28:0] as a row address, having a logic [14:12] as a bank address, and having a logic [11:2] as a column address. Incidentally, the first address translation expression and the second address translation expression are not limited to the above-described translation expressions.

As shown in FIG. 1, the scheduler 3b is adapted to arbitrate access to the first DRAM 4 and access to the second DRAM 5.

In a first case where the DRAM address specifies a first address al of the first storage area 4a in the first DRAM 4 and the third storage area 5a in the second DRAM 5, the command/data transformation unit 3c is adapted to output a first read command RD1 for the first address a1 at the time of read operation. In the first case, the command/data transformation unit 3c is adapted to output a first write command WD1 to the first address a1 at the time of write operation.

In addition, the command/data transformation unit 3c is adapted to output data read from the first storage area 4a in the first DRAM 4 and the third storage area 5a in the second DRAM 5 to the process units 1a and 1b via the bus 2 at the time of read operation in the first case.

The command/data transformation unit 3c is adapted to divide data, which is input from the process units 1a and 1b via the bus 2, into first data D1 and second data D2 and output the first data D1 and the second data D2 to the first DRAM 4 and the second DRAM 5 at the time of write operation in the first case.

On the other hand, in a second case where the DRAM address specifies a second address a2 in the second storage area 4b in the first DRAM, the command/data transformation unit 3c is adapted to output a second read command RD2 for a second address a2 at the time of read operation and generate and output a third read command RD3 for a third address a3 in the second storage area 4b which is not specified in address by the DRAM address.

The command/data transformation unit 3c is adapted to output a second write command WD2 for the second address a2 and generate and output a third write command WD3 for the third address a3 in the second storage area 4b which is not specified in address by the DRAM address at the time of write operation in the second case.

In addition, the command/data transformation unit 3c is adapted to output data read from storage area 4b in the first DRAM 4 to the process units 1a and 1b via the bus 2 at the time of read operation in the second case.

The command/data transformation unit 3c is adapted to divide data, which is input from the process units 1a and 1b via the bus 2, into third data D3 and fourth data D4 and output the third data D3 and the fourth data D4 to the storage area 4b in the first DRAM 4 at the time of write operation in the second case.

The DRAM control signal generation unit 3d is adapted to generate and output the DRAM control signal based on the DRAM address and the first to third read commands RD1 to RD3 (or the first to third write commands WD1 to WD3) which are output from the command/data transformation unit 3c.

The mask unit 3e is adapted to output the DRAM control signal to the first DRAM 4 and the second DRAM 5 in the first case where the DRAM address specifies the first address a1. On the other hand, the mask unit 3e is adapted to output the DRAM control signal to only the first DRAM 4 (i.e., mask the access to the second DRAM 5) in the second case where the DRAM address specifies the second address a2.

An example of operation of the memory system 100 having the configuration described heretofore will now be described.

First, an example of read operation of the memory system 100 will be described.

(1) First case where the DRAM address specifies the first address a1

First, upon being input of a logical address from the process units 1a and 1b via the bus 2, the address translation unit 3a translates the logical address to a DRAM address based on the first address translation expression.

Upon being input of a read command from the process units 1a and 1b via the bus 2, the command/data transformation unit 3c outputs the first read command RD1 for the first address a1 because the DRAM address specifies the first address a1.

The DRAM control signal generation unit 3d generates and outputs the DRAM control signal based on the DRAM address and the first read command RD1 which is output from the command/data transformation unit 3c.

Since the DRAM address specifies the first address a1, the mask unit 3e outputs the DRAM control signal to the first DRAM 4 and the second DRAM 5.

According to the DRAM control signal, the first DRAM 4 reads the first data D1 stored at the first address a1 in the first storage area 4a and the second DRAM 5 reads the second data D2 stored at an address having the same numerical value as the first address a1 in the third storage area 5a.

The command/data transformation unit 3c outputs data obtained by joining together the first data D1 and the second data D2 read respectively from the first DRAM 4 and the second DRAM 5 to the process units 1a and 1b via the bus 2.

(2) Second case where the DRAM address specifies the second address a2

First, upon being input of a logical address from the process units 1a and 1b via the bus 2, the address translation unit 3a translates the logical address to a DRAM address based on the second address translation expression and outputs the DRAM address.

Upon being input of a read command from the process units 1a and 1b via the bus 2, the command/data transformation unit 3c outputs the second read command RD2 for the second address a2 and generates and outputs the third read command RD3 for the third address a3 in the second storage area 4b which is not specified in address by the DRAM address.

The DRAM control signal generation unit 3d generates and outputs the DRAM control signal based on the DRAM address and the second read command RD2 and the third read command RD3 which are output from the command/data transformation unit 3c.

Since the DRAM address specifies the second address a2, the mask unit 3e outputs the DRAM control signal only to the first DRAM 4 (i.e., masks the access to the second DRAM 5).

According to the DRAM control signal, the first DRAM 4 reads the third data D3 stored at the second address a2 in the second storage area 4b and the fourth data D4 stored at the third address a3 in the second storage area 4b.

The command/data transformation unit 3c outputs data obtained by joining together the third data D3 and the fourth data D4 read from the first DRAM 4 to the process units 1a and 1b via the bus 2.

In other words, the process units 1a and 1b do not access the second DRAM 5 in the second case.

An example of write operation of the memory system 100 will now be described.

(1) First case where the DRAM address specifies the first address a1

First, upon being input of a logical address from the process units 1a and 1b via the bus 2, the address translation unit 3a translates the logical address to a DRAM address based on the first address translation expression, and outputs the DRAM address.

Upon being input of a write command from the process units 1a and 1b via the bus 2, the command/data transformation unit 3c outputs the first write command WD1. In addition, the command/data transformation unit 3c divides data, which is input from the process units 1a and 1b via the bus 2, into first data D1 and second data D2, and outputs the first data D1 and the second data D2 respectively to the first DRAM 4 and the second DRAM 5.

The DRAM control signal generation unit 3d generates and outputs the DRAM control signal based on the DRAM address and the first write command WD1 which is output from the command/data transformation unit 3c.

Since the DRAM address specifies the first address a1,the mask unit 3e outputs the DRAM control signal to the first DRAM 4 and the second DRAM 5.

According to the DRAM control signal, the first DRAM 4 writes the first data D1 at the first address a1 in the first storage area 4a and the second DRAM 5 writes the second data D2 at an address having the same numerical value as the first address al in the third storage area 5a.

(2) Second case where the DRAM address specifies the second address a2

First, upon being input of a logical address from the process units 1a and 1b via the bus 2, the address translation unit 3a translates the logical address to a DRAM address based on the second address translation expression, and outputs the DRAM address.

The command/data transformation unit 3c outputs the second write command WD2 for the second address a2 and generates and outputs the third write command WD3 for the third address a3 in the second storage area 4b which is not specified in address by the DRAM address. In addition, the command/data transformation unit 3c divides data, which is input from the process units 1a and 1b via the bus 2, into third data D3 and fourth data D4, and outputs the third data D3 and the fourth data D4 to the first DRAM 4.

The DRAM control signal generation unit 3d generates and outputs the DRAM control signal based on the DRAM address and the second write command WD2 and the third write command WD3 which are output from the command/data transformation unit 3c.

Since the DRAM address specifies the second address a2, the mask unit 3e outputs the DRAM control signal only to the first DRAM 4 (i.e., masks the access to the second DRAM 5).

According to the DRAM control signal, the first DRAM 4 writes the third data D3 at the second address a2 in the second storage area 4b and the fourth data D4 at the third address a3 in the second storage area 4b.

In other words, the process units 1a and 1b do not access the second DRAM 5 in the second case.

As described heretofore, the memory system 100 can control access to two DRAMs having different capacities by using one controller.

The process units 1a and 1b retain information that the bandwidth obtained when accessing the first DRAM 4 and the second DRAM 5 by specifying an address in the first storage area 4a is doubled as compared with when accessing only the first DRAM 4 by specifying an address in the second storage area 4b.

In other words, for example, in the case where a large memory bandwidth is required, the process units 1a and 1b specify a logical address which makes it possible to access the first storage area 4a and the third storage area 5a and consequently the memory controller controls 32-bit width access to the DRAM 4 and the DRAM 5. On the other hand, for example, in the case where a large memory bandwidth is not required, the process units 1a and 1b specify a logical address which makes it possible to access the second storage area 4b and consequently the memory controller controls 16-bit width access to the DRAM 4.

In the memory system according to the present embodiment, access to two DRAMs having different capacities can be controlled by using one controller as described heretofore.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

What is claimed is:

1. An information processing apparatus comprising:
a process unit;
a first memory having a first storage area and a second storage area;
a second memory having a third storage area which has an address space being the same as an address space of the first storage area; and
a memory controller which controls writing into the first memory and writing into the second memory based on a logical address and a write command provided from the process unit,
the memory controller comprising:
an address translation unit which translates a logical address provided from the process unit to a physical address for accessing the first memory and the second memory;
a command/data transformation unit which outputs data to be written to areas in the first memory and the second memory which are specified by the physical address,
the address translation unit performing address translation of the logical address based on a first address translation expression when the process unit performs writing to the first storage area and the third storage area, and
the address translation unit performing address translation of the logical address based on a second address translation expression which is different from the first address translation expression when the process unit performs writing to the second storage area.

2. The information processing apparatus according to claim 1, wherein when performing writing to the first storage area and the third storage area, the command/data transformation unit divides data to be written and writes separately each piece of data obtained by the division to areas in the first memory and the second memory which are specified by a same physical address.

3. The information processing apparatus according to claim 2, wherein
when performing access having a narrow bandwidth, the process unit divides data to be written and write data obtained by the division into the second storage area successively,
when performing access having a wide bandwidth, the process unit divides data to be written and writes separately each piece of data obtained by the division to areas in the first memory and the second memory which are specified by a same physical address.

4. The information processing apparatus according to claim 3, wherein the address translation unit uses the first address translation expression or the second address translation expression based on information of a predetermined bit of a logical address provided from the process unit.

5. The information processing apparatus according to claim 4, wherein
the memory controller further comprises a mask unit, and
the mask unit masks access to the second memory when performing writing into the second storage area.

6. The information processing apparatus according to claim 5, wherein a bandwidth of the first memory is equal to a bandwidth of the second memory.

7. The information processing apparatus according to claim 6, wherein the first memory and the second memory are main memories.

8. The information processing apparatus according to claim 7, wherein the first memory and the second memory are DRAMs.

9. An information processing apparatus comprising:
a process unit;
a first memory having a first storage area and a second storage area;
a second memory having a third storage area which has an address space being the same as an address space of the first storage area; and
a memory controller which controls reading data from the first memory and reading data from the second memory based on a logical address and a read command provided from the process unit,
the memory controller comprising:
an address translation unit which translates a logical address provided from the process unit to a physical address for accessing the first memory and the second memory;
a command/data transformation unit which outputs data read from areas in the first memory and the second memory which are specified by the physical address,
the address translation unit performing address translation of the logical address based on a first address translation expression when the process unit performs reading data from the first storage area and the third storage area, and
the address translation unit performing address translation of the logical address based on a second address translation expression which is different from the first address translation expression when the process unit performs reading data from the second storage area.

10. The information processing apparatus according to claim 9, wherein when reading data from the first storage area and the third storage area, the command/data transformation unit reads data from a area in the first storage area and a area in the third storage area which are specified by the same physical address.

11. The information processing apparatus according to claim 10, wherein
when performing access having a narrow bandwidth, the process unit reads data from the second storage area successively,
when performing access having a wide bandwidth, the process unit reads data from areas in the first memory and the second memory which are specified by a same physical address separately,

12. A memory controller which controls writing into a first memory and writing into a second memory based on a logical address and a write command provided from the process unit, the first memory having a first storage area and a second storage area, the second memory having a third storage area which has an address space being the same as an address space of the first storage area, the memory controller comprising:
an address translation unit which translates a logical address provided from the process unit to a physical address for accessing the first memory and the second memory;
a command/data transformation unit which outputs data to be written to areas in the first memory and the second memory which are specified by the physical address,
the address translation unit performing address translation of the logical address based on a first address translation expression when the process unit performs writing to the first storage area and the third storage area, and
the address translation unit performing address translation of the logical address based on a second address translation expression which is different from the first address translation expression when the process unit performs writing to the second storage area.

13. The memory controller according to claim 12, wherein when performing writing to the first storage area and the third storage area, the command/data transformation unit divides data to be written and writes separately each piece of data obtained by the division to areas in the first memory and the second memory which are specified by a same physical address.

14. The memory controller according to claim 13, wherein the address translation unit uses the first address translation expression or the second address translation expression based on information of a predetermined bit of a logical address provided from the process unit.

15. The memory controller according to claim 14, wherein
the memory controller further comprises a mask unit, and
the mask unit masks access to the second memory when performing writing into the second storage area.
